(19) United States
(12) Patent Application Publication
(10) Pub. No.: US 2003/0155193 A1
(43) Pub. Date: Aug. 21, 2003

(54) Non-metallic brake plate

(76) Inventors: William D. Hays JR., Rock Hill, SC (US); Robert W. Stewart, Rock Hill, SC (US); Daniel W. Donnell, Charlotte, NC (US)

Correspondence Address: CARLSON, GASKEY & OLDS, P.C., 400 WEST MAPLE ROAD, SUITE 350, BIRMINGHAM, MI, 48009, US

(21) Appl. No.: 10/079,692

(22) Filed: Feb. 20, 2002

(51) Int. Cl. F16D 69/00

(52) U.S. Cl. 188/250 R; 188/73.1; 188/73.31

(57) ABSTRACT

A plate for use in a vehicle brake assembly is made from a non-metallic material. In one example, a wet disc brake assembly plate is made from a phenolic material. In another example, a backing plate for a disc brake or drum brake assembly is made from a non-metallic composite and has a friction pad secured to at least one side.

### BACKGROUND OF THE INVENTION

This invention generally relates to vehicle brake systems. More particularly, this invention relates to a brake plate made from a non-metallic material.

Vehicle brake assemblies typically include friction pads that are supported on backing plates. Traditionally, stamped steel backing plates are used to support the friction pads, which engage a rotating drum or rotor during a braking application. Conventional methods of securing the friction pad to the steel backing plate include riveting, or bonding using an adhesive, or direct molding of the friction material to the steel back plate.

Although steel backing plates have proven useful, they are not without shortcomings and drawbacks. For example, it is possible for a friction pad to be separated from the steel plate over time. Possible causes of separation include corrosion of the steel or the friction material, thermal breakdown of the adhesive used to bond the components together, or loss of strength in the friction material in the vicinity of the rivets due to thermo-mechanical fatigue. Another shortcoming associated with steel backing plates is that they require multiple processing steps for complete assembly.

In the case of wet disc brakes, the steel rotor and stator plates typically are machined or stamped and then ground to a finished size. There is an additional expense added because rotor plates for such assemblies have a paper-based friction material adhered to both sides of the backing plate. The multiple steps involved in making such plates introduces additional cost that it would be advantageous to avoid.

This invention overcomes the shortcomings and drawbacks mentioned above by providing a non-metallic backing plate. Although non-metallic plates have been used in clutches, for example, they have not been effectively used in braking assemblies prior to this invention.

### SUMMARY OF THE INVENTION

In general terms, this invention is a brake assembly having a non-metallic plate. In one example, the brake assembly is a wet disc brake assembly with braking plates that are made from a non-metallic material. In the preferred embodiment, the wet disc braking plates are molded using a phenolic material.

In another example, the non-metallic backing plate has a friction pad adhered to at least one side. This particular example is useful in conventional disc or rotor brake assemblies. The preferred embodiment includes a fiber-reinforced thermosetting resin matrix composite material that is used when making the backing plate.

The various features and advantages of this invention will become apparent to those skilled in the art from the following detailed description of the currently preferred embodiments. The drawings that accompany the detailed description can be briefly described as follows.

### BRIEF DESCRIPTION OF THE DRAWINGS

FIG. 1 illustrates a brake shoe design according to this invention.

FIG. 2 shows the embodiment of FIG. 1 from a side view.

FIG. 3 illustrates an alternative attachment arrangement for securing a friction pad to a backing plate designed according to this invention.

FIGS. 4a and 4b illustrate another attachment arrangement.

FIG. 5 illustrates a wet disc brake plate designed according to this invention.

### DETAILED DESCRIPTION OF THE PREFERRED EMBODIMENTS

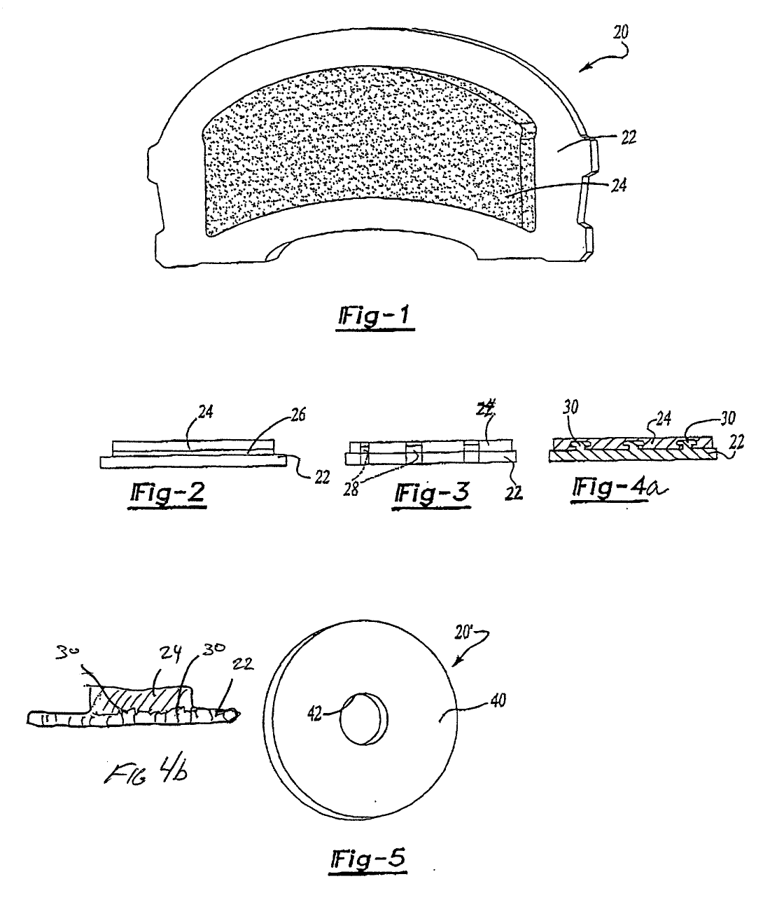

FIG. 1 illustrates a brake shoe 20 that has a backing plate 22 and a friction pad 24. The backing plate 22 preferably is made from a non-metallic material. In one example, a fiber-reinforced thermosetting resin matrix composite is used to make the backing plate 22. The backing plate 22 preferably is made using a molding process that results in a finish product that does not require any further machining or processing.

The friction pad 24 preferably is secured to the backing plate 22 so that there is no separation between the backing plate 22 and the pad 24 during use of the brake shoe 20. FIG. 2 illustrates a first example where an adhesive 26 is used to secure the friction pad 24 to the backing plate 22. FIG. 3 illustrates another example where rivets 28 are used to secure the friction pad 24 to the backing plate 22.

FIGS. 4a and 4b illustrate further examples where the backing plate 22 includes portions 30 that are integrally molded as part of the friction pad 24 during a molding process. The shape or form of the portions 30 may vary depending on the needs of a given situation. An arrangement such as that shown in FIG. 4a or 4b has significant advantages because the backing plate 22 is molded with the friction pad 24 and effectively becomes part of the friction pad 24. This greatly enhances the ability to maintain the friction pad 24 in place on the backing plate 22. When this technique is used, there is more than a single plane attachment between the friction pad 24 and the backing plate 22, which enhances strength. Additionally, using a technique as schematically illustrated in FIG. 4 reduces the costs associated with making the brake shoe 20 because multiple process steps are combined into a single process.

The material used for the friction pad 24 can be any conventional material. Those skilled in the art that have the benefit of this description will be able to choose from among suitable materials and choose the appropriate securing strategy for their particular situation.

There are significant advantages presented by using a non-metallic backing plate 22. First, corrosion is effectively eliminated, which otherwise occurred using steel backing plates. Second, the non-metallic backing plate 22 is significantly lighter than a conventional backing plate. Third, the thermal conductivity of the brake shoe 20 is reduced, which results in reducing the temperature at the brake system caliper seals and the temperature of the brake fluid. Reducing temperatures reduces wear and the potential for excessive fluid temperatures during heavy duty use. Another advantage is that the thermal expansion properties of the backing plate 22 are much closer to those of the friction pad 24, which reduces bond line stress and improves the integrity and strength of the overall structure.

Another example of this invention is shown in FIG. 5. A wet disc brake 20′ is made from a non-metallic material. The preferred embodiment includes a phenolic material. In one example, a friction modifying compound is mixed into the phenolic powder prior to molding the disc 20′. The friction modifying compound may also reinforce the plate structure. Different material combinations may be selected to achieve different friction characteristics depending on the needs of a particular situation. Other examples include a fiber-reinforced phenolic material or a phenolic matrix composite. Given this description, those skilled in the art will be able to choose from among available materials to achieve desired results. The plate 20′ is useable as a stator plate or rotor plate in a wet disc assembly.

The wet disc brake plate 20′ has a friction surface 40 that engages other wet disc plates in an assembly as known in the wet disc brake art. An opening 42 preferably is provided through the center of the disc 20′ to receive a hub or shaft along which the disc is selectively movable.

A wet disc brake plate designed according to this invention has advantages compared to conventional arrangements. For example, there is no need to machine or otherwise finish a plate that has been stamped out of steel as was previously necessary. With this invention, the wet disc plate is molded to a finished size and ready for installation without further processing. Moreover, conventional plates require a paper-based friction material adhered to each side. A wet disc plate designed according to this invention does not require a separate friction pad material, which results in economies of manufacturing and materials.

The preceding description is exemplary rather than limiting in nature. Variations and modifications to the disclosed embodiments may become apparent to those skilled in the art that do not necessarily depart from the purview and spirit of this invention. The scope of legal protection given to this invention can only be determined by studying the following claims.

We claim:

1. A brake plate for use in a vehicle brake assembly comprising:
a non-metallic body.

2. The plate of claim 1, wherein the plate is a backing plate and including a friction pad supported on one surface of the body.

3. The plate of claim 2, wherein the friction pad is adhesively secured to the body.

4. The plate of claim 2, wherein the friction pad is riveted to the body.

5. The plate of claim 2, wherein the body includes a portion that is molded integrally with a portion of the friction pad.

6. The plate of claim 1, wherein the plate is adapted to be used in a wet disc brake assembly and the body comprises a phenolic material.

7. The plate of claim 6, wherein the body comprises a fiber reinforced phenolic material.

8. The plate of claim 6, wherein the body comprises a phenolic matrix composite material.

9. The plate of claim 1, wherein the body comprises a fiber-reinforced thermosetting resin matrix composite material.

10. A method of making a plate for use in a vehicle brake assembly comprising:
molding a non-metallic material into the shape of a brake plate.

11. The method of claim 10, including mixing a friction modifying compound with a phenolic powder prior to performing the molding step.

12. The method of claim 11, including using a fiber reinforced phenolic powder.

13. The method of claim 11, including using a friction modifying compound that also reinforces the phenolic powder.

14. The method of claim 10 including securing a friction pad to the molded plate.

15. The method of claim 14 including adhesively securing the friction pad to the plate.

16. The method of claim 14 including riveting the friction pad to the molded plate.

17. The method of claim 14 including integrally molding at least a portion of the plate with at least a portion of the friction pad.
